(19) United States
(12) Patent Application Publication
(10) Pub. No.: US 2005/0092537 A1
(43) Pub. Date: May 5, 2005

(54) Air powered tire assembly handling device

(76) Inventor: Larry Szeliga, Lindale, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/696,820

(22) Filed: Oct. 30, 2003

(51) Int. Cl. B60V 1/00

(52) U.S. Cl. 180/116

(57) ABSTRACT

A device for moving a tire assembly about a floor surface and mounting the tire assembly to a vehicle, the device includes a platform configured for moving about the floor surface, a pneumatic source for providing a layer of air between the platform and the floor surface beneath said platform, and a support mounted on the platform. The support defining a horizontally extending central axis and is configured to receive and support the tire assembly. An elevator is connected to the platform and the support, and is configured to raise and lower the support relative to said platform. The device is supported on the layer of air so that the platform is movable above the floor surface.

### TECHNICAL FIELD

The present invention generally relates to devices for assisting a user to more easily mount a tire assembly on a vehicle. More particularly, the invention relates to an air assisted device for transporting a tire assembly about a support surface and positioning the tire assembly for mounting to a vehicle.

### BACKGROUND OF THE INVENTION

In many original equipment manufacturing (OEM) facilities, tire assemblies comprised of a rim and a tire are moved from assembly line storage areas to the assembly line, on which the vehicles are being assembled, for installation on those vehicles. The task of lifting the tire assembly, moving it to the assembly line, and mounting it on the vehicle is frequently a complicated and dangerous operation. While many tire assemblies can weigh as little as a few pounds, others can weigh thousands of pounds depending on the type and size vehicle on which they are to be mounted. Similar operations posing similar hazards are also conducted in repair and retail facilities where vehicles are serviced.

When practical, the handling of tire assemblies is typically performed manually, where one or more people physically move the tire assembly from storage and mount it on the vehicle by physical force. However, when the weight of the tire assembly (for example, over 70 pounds) makes the use of physical force both impractical and hazardous, mechanical devices such as jacks, hoists, and fork lifts are utilized to assist in the handling process. At present, each of the methods has various drawbacks, as discussed in greater detail below.

Manually mounting large tire assemblies poses obvious health and safety risks. For example, improper lifting techniques can lead to back and muscle problems as well as safety concerns when persons attempt to mount tire assemblies of greater size (i.e., width, height, diameter, and weight) than their physical capabilities allow. Also note that even light to moderate weight tire assemblies can be handled improperly, therefore creating similar health and safety concerns.

Typical tire jacks consist of lifting devices mounted on wheels or casters. Existing devices have several drawbacks. For example, known lifting devices typically do not provide small enough vertical lift increments for adequately adjusting the tire assembly to the desired height for mounting the tire assembly on the vehicle. Additionally, the tire assembly is typically supported on stationery extensions of the tire jack, meaning the tire assembly cannot be adequately rotated such that the bolt holes of the tire assembly adequately align with the lugs or lug holes present on the mounting surface of the vehicle. As noted, existing tire jacks are frequently mounted on wheels or casters which lead to other drawbacks when moving tire assemblies from location to location. For example, initiating motion of the tire assembly and jack, changing directions of the loaded jack, and stopping the forward movement of the loaded jack often require large amounts of force.

Overhead lifting devices, including hoists or cranes with hooks or other grabbing devices for grasping the tire assembly, are used to lift the tire assembly out of storage, transport it to the vehicle, and maneuver it into an adequate position for mounting to the vehicle. Overhead lifting methods pose the obvious danger associated with moving heavy objects above an inhabited work area. The potential exists for the elevated tire assembly to collide directly with a person or equipment during transport, thereby causing injury to the person and damage to the equipment. As well, the potential exists that while transporting and moving the elevated tire assembly, the tire assembly could be inadvertently released, thereby injuring persons below and/or damaging equipment.

Although forklifts tend to provide more control while maneuvering tire assemblies, confined/congested areas, such as those typically associated with vehicle assembly lines and maintenance areas, often make it difficult to adequately maneuver the forklift. As well, forklifts pose a significant threat to those people in and around the area where the forklift is operated.

From the foregoing, it can be appreciated that it would be desirable to have an air assisted tire handling device that can be used for both transporting a tire assembly about a support surface and positioning the tire assembly for mounting to a vehicle. Thus, a heretofore unaddressed need exists in the industry to address the aforementioned deficiencies and inadequacies.

### SUMMARY OF THE INVENTION

Briefly described, an embodiment of an air assisted tire assembly handling device for moving a tire assembly about a floor surface and mounting the tire assembly to a vehicle includes a platform configured for moving about the floor surface, a pneumatic source for providing a layer of air between the platform and the floor surface beneath the platform, and a support mounted on the platform. The support defines a horizontally extending central axis and is configured to receive and support the tire assembly. An elevator is connected to the platform and the support and is configured to raise and lower the support relative to the platform. The device is supported on the layer of air so that the platform is movable above the floor surface.

Another embodiment of an air assisted tire assembly handling device for moving a tire assembly about a floor surface and mounting the tire assembly to a vehicle includes a platform configured for moving about the floor surface and a support mounted on the platform, the support defining a horizontally extending central axis. An elevator is connected to the platform and the support and is configured to raise and lower the support relative to said platform. A cradle is mounted on the support and is rotatable about the central axis. The cradle includes a pair of wheel engaging supports spaced from each other a distance less than a diameter of the tire assembly for supporting the tire assembly in an upright attitude, so that the tire assembly positioned in the cradle is elevated to a desired height by the elevator and is rotatable about the central axis to align the tire assembly with the vehicle. The platform is movable toward the vehicle to engage the tire assembly with the vehicle for mounting.

Yet another embodiment of an air assisted tire assembly handling device for moving a tire assembly about a floor surface and mounting the tire assembly to a vehicle includes a platform configured for moving about the floor surface and a support movably connected to the platform, the support defining a horizontally extending central axis. The support includes a pair of tire engaging supports spaced from each other a distance less than a diameter of the tire assembly for supporting the tire assembly in an upright position. An elevator is connected to the platform and the support for raising and lowering the support relative to the platform. A tire tilt restrainer is rotatably mounted to one of the tire engaging supports and includes a bearing sleeve rotatably disposed about the tire engaging support and a restrainer plate connected to the bearing sleeve perpendicular to the central axis. The restrainer plate is configured to maintain the tire assembly in an upright position when the tire assembly is supported by the pair of wheel engaging supports.

Yet another embodiment of an air assisted tire assembly handling device for moving a tire assembly about a floor surface and mounting the tire assembly to a vehicle includes a platform configured for moving about the floor surface and a support mounted on the platform, the support defining a horizontally extending central axis and being configured to receive and support the tire assembly. The device also includes means for raising and lowering the support relative to the platform and means for creating a layer of air between the platform and the floor surface. The apparatus is supported on the layer of air so that the platform is movable above the floor surface.

Other systems, methods, features and advantages of the present air assisted tire assembly handling device will be or become apparent to one with skill in the art upon examination of the following drawings and detailed description. It is intended that all such additional systems, methods, features and advantages be included within this description, and be within the scope of the air assisted tire assembly handling device, and be protected by the accompanying claims.

### BRIEF DESCRIPTION OF THE DRAWINGS

The air assisted tire assembly handling device can be better understood with reference to the following drawings. The components in the drawings are not necessarily to scale, emphasis instead being placed upon clearly illustrating the principles of the air assisted tire assembly handling device. Moreover, in the drawings, like reference numerals designate corresponding parts throughout the several views.

FIG. 1 is a front view of an embodiment of an air assisted tire assembly handling device in accordance with the present invention.

FIG. 2 is a back view of the air assisted tire assembly handling device as shown in FIG. 1.

FIG. 3 is a partially cut-away, top view of the air assisted tire assembly handling device as shown in FIG. 1.

FIG. 4 is a partially cut-away, side view of the air assisted tire assembly handling device as shown in FIG. 1.

FIG. 5 is a front view of the air assisted tire assembly handling device as shown in FIG. 1, being used to lift and rotate a tire assembly.

Reference will now be made in detail to the description of the air assisted tire assembly handling device as illustrated in the drawings. While the tire assembly handling device will be described in connection with these drawings, there is no intent to limit the air assisted tire assembly handling device to the embodiment or embodiments disclosed therein. On the contrary, the intent is to cover all alternatives, modifications, and equivalents included within the spirit and scope of the air assisted tire assembly handling device as defined by the appended claims.

### DETAILED DESCRIPTION OF THE PREFERRED EMBODIMENT

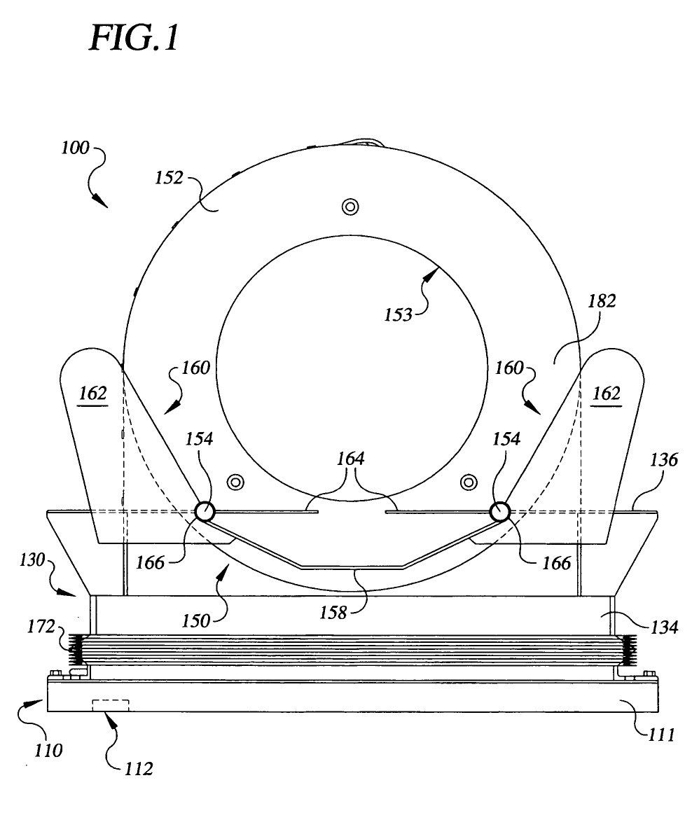

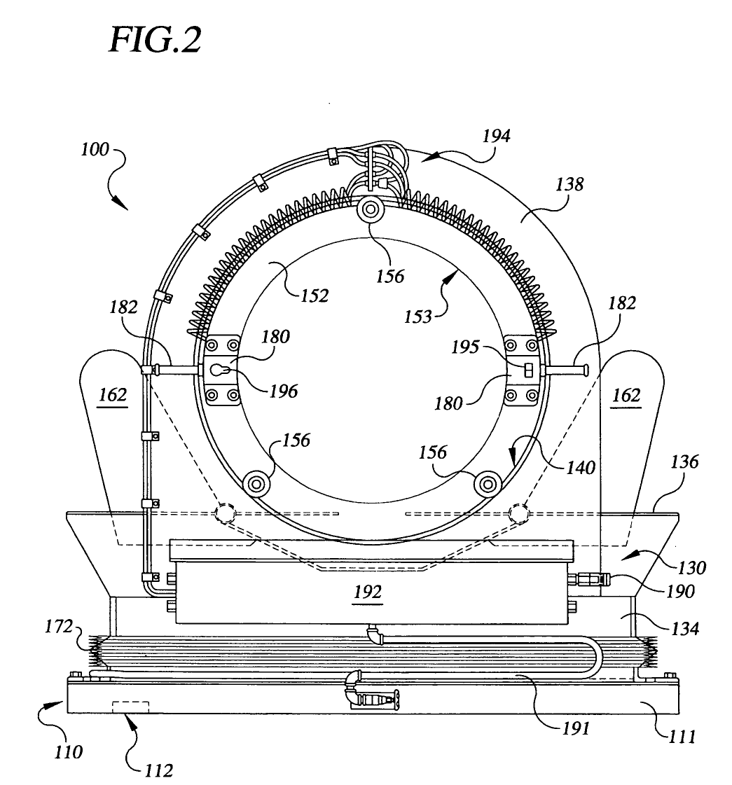

Referring now in more detail to the drawings, in which like numerals indicate like parts throughout the several views, FIGS. 1 and 2 illustrate an embodiment, among others, of an air assisted tire assembly handling device 100. The tire assembly handling device 100 includes a platform 110, a support 130, a cradle 150, and an elevator 170 disposed between the platform 110 and the support 130.

The platform 110 is constructed of steel, aluminum, plastic, fiberglass, or other like materials, but preferably steel. A plurality of air casters 112, such as those that are known in the art, is disposed on the underside of the platform 110. An exemplary air caster 112 is Model “Series Air,” sold by Hovair Automotive NDC. The plurality of air casters 112 are arranged and configured to provide a layer of air between the platform 110 and a support surface disposed thereunder, thereby lifting the tire assembly handling device 100 such that the tire assembly handling device 100 may be readily moved about the support surface. Preferably, an air restraining skirt 111 depends downwardly from the periphery of the platform 110 to prevent the unimpeded flow of air from the air casters 112 to the surrounding environment. The air restraining skirt 111 is typically of the same material as the platform 110, preferably steel.

The elevator 170 is supported on the upper surface of the platform 110 and is further connected to the bottom portion 134 of the support 130. Preferably, the elevator 170 comprises a pneumatically operated, scissor-type jack. Preferably, an external pneumatic source (not shown) is connected to the tire assembly handling device 100 at a pneumatic fitting 190. A flexible air hose 191 insures air is provided to the components on the platform 110 during operations. Various embodiments of the tire assembly handling device 100 are possible wherein the elevator 170 is other than a scissor-type jack, and wherein the elevator is operated hydraulically, mechanically, or pneumatically.

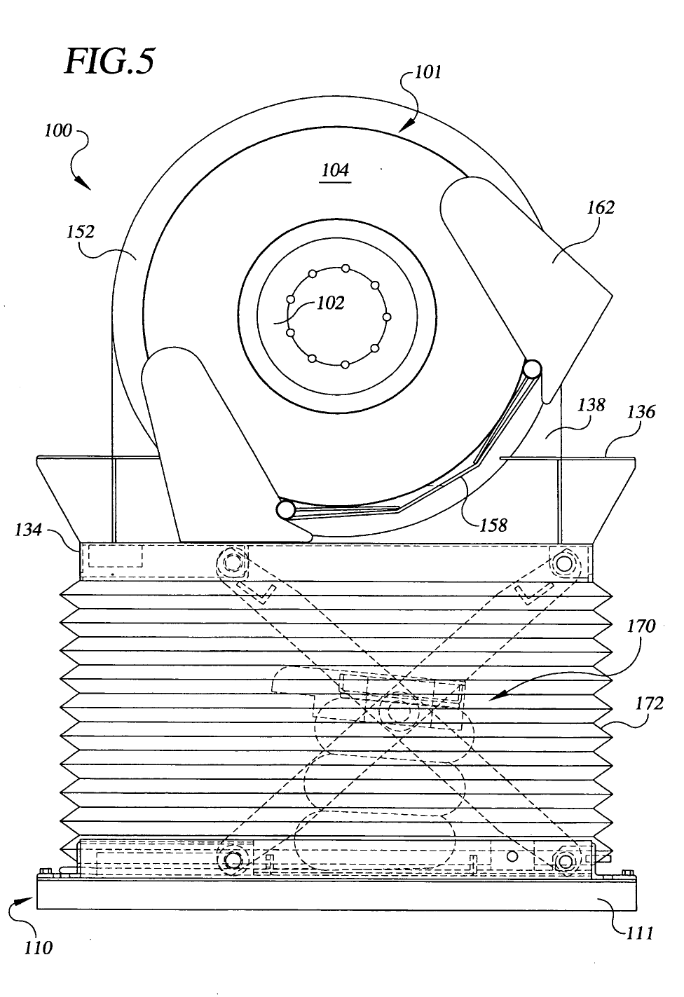

The support 130 also includes a vertical wall 138 and, preferably, a pair of tire receiving platforms 136 disposed on the bottom portion 134. Although embodiments of the tire assembly handling device 100 are possible having a single tire receiving platform 136, two tire receiving platforms 136 allow a user to load a tire assembly 101 (FIG. 5), including a tire 104 and a rim 102, from either side of the device. The vertical wall 138 includes a circular opening 140 formed about a horizontally extending axis. The circular opening 140 supports the cradle 150 in a rotatable fashion.

The cradle 150 includes a back plate 152 that defines a central opening 153, the central opening also being formed about the horizontally extending axis of the support 130. Preferably, the back plate 152 is circular, although other shapes are possible. The backside of the back plate 152 includes a plurality of bearings 156 arranged and configured such that the bearings 156 are in contact with and moveable along the circular opening 140 of the support 130. As such, the bearings 156 rotatably secure the back plate 152, and therefore cradle 150, to the support 130. Preferably, the backside of the back plate 152 also includes a pair of control arms 180, each having a handle 182 disposed thereon. The control arms 180 and handles 182 assist a user in rotating the cradle 150 within the circular opening 140.

The cradle 150 further includes a pair of tire engaging supports 154 extending outwardly from the front side of the back plate 152. The tire engaging supports 154 are positioned on the back plate 152 such that the distance between the tire engaging supports 154 is less than the diameter of a tire assembly 101 which is to be placed in the cradle 150. Preferably, a tire cradle plate 158 is disposed on the front side of the back plate 152 between the tire engaging supports 154. As shown, the tire cradle plate 158 is supported by the tire engaging supports 154 as well as the back plate 152. As shown, each tire engaging support 154 further includes a tire tilt restrainer 160 disposed thereon.

Each tire tilt restrainer 160 includes a bearing sleeve 166 that is rotatingly disposed on a respective tire engaging support 154. Further, each tire tilt restrainer 160 includes a receiver plate 164 extending radially from the bearing sleeve 166 and a restrainer plate 162 connected to the outermost portion of the bearing sleeve 166. Preferably, each restrainer plate 162 is configured such that when a tire assembly 101 is not supported on the cradle 150, the tire assembly handling device 100 may be positioned with relative ease beneath a tire assembly 101 that is mounted on a vehicle. As well, each restrainer plate 162 is also configured such that when a tire assembly 101 contacts the pair of receiver plates 164, thereby causing the receiver plates 164 to rotate downwardly and into contact with the tire cradle plate 158, the restrainer plates 162 are rotated into a position which will maintain the tire assembly 101 in an upright attitude (FIG. 5).

The restrainer plates 162 may have any number of shapes, dependent on large part upon the size tire assembly 101 to be maneuvered as well as the type vehicle on which the tire assembly handling device 100 is being used. Further, embodiments are possible wherein the tire cradle plate 158 is not required so long as the rotation of the tire tilt restrainers 160 about their respective tire engaging supports 154 can be limited. For example, a pair of limits or stops extending from the front side of the back plate 152 could be used to limit the rotation the restrainer plates 162, thereby supporting the tire assembly 101 disposed thereon.

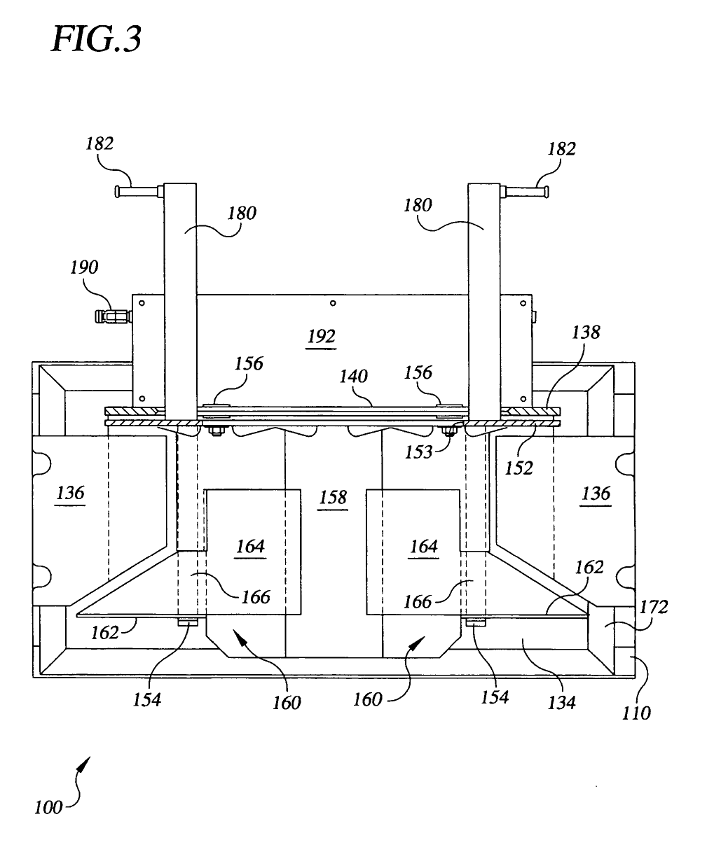

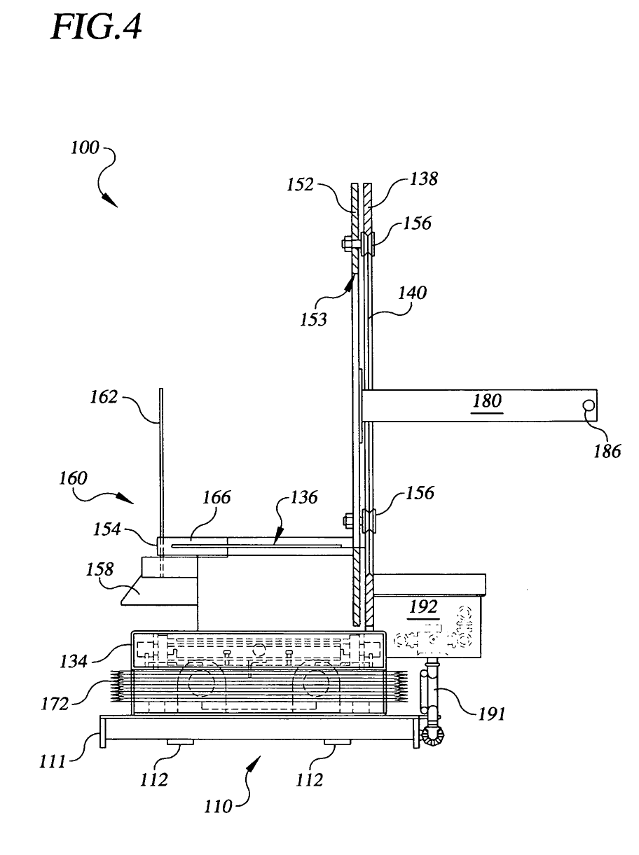

Referring now to FIGS. 3 and 4, top and side views of the tire assembly handling device 100 are shown, with portions of the vertical wall 138 and the back plate 152 cut-away to better show both how the bearings 156 travel along the circular opening 140 and how the control arms 180 are mounted to the backside of the back plate 152. As shown, each side of the circular opening 140 is beveled such that the circular opening 140 has a triangular cross-section along its circumference. Each bearing 156 defines a complimentary, triangular mating surface about its circumference, such that the bearings 156 secure the cradle 150 to the vertical wall 138 in rotatable fashion. Note also, embodiments are possible wherein the bearings 156 are secured to the vertical wall 138 and travel along a circular opening formed in the back plate 152.

### Operation

During a typical tire assembly 101 mounting process, the tire assembly handling device 100 is first connected to a pneumatic source (not shown). Preferably the pneumatic source is external, such as a compressor, that is connected to the tire assembly handling device 100 by way of the pneumatic fitting 190 (FIG. 2). Typical operating pressures for the tire assembly handling device 100 range from 60 to 80 pounds per square inch (PSI). The flow of air to the various components of the tire assembly handling device 100 is then controlled with the caster switch 196, the lift switch 195, and a plurality of pneumatic lines 194. To move the tire assembly handling device 100 into position for loading, a user depresses the caster switch 196, thereby providing air to the casters 112 disposed on the underside of the platform 110. Depressing the caster switch 196 causes air from the pneumatic source to flow through the air hose 191 so that it is evenly distributed amongst the plurality of casters 112. In turn, the plurality of casters 112 create a layer of air between the platform 110 and a support surface disposed beneath the tire assembly handling device 100. The air restrainer skirt 111 helps to maintain the layer of air between the platform 110 and the support surface by retaining as much air as possible between the platform 110 and the support surface. Once the layer of air has been created, the user may move the tire assembly handling device 100 into loading position by exerting force on the handles 182.

After the tire assembly handling device 100 is adjacent the location of the stored tire assemblies, if necessary, the lift switch 195 is depressed thereby causing air to flow to the elevator 170, as shown in FIG. 5, causing the support 130 to be moved vertically away from the platform 110. Preferably, the lift switch 195 is configured such that depressing an upper portion causes the support 130 to move up and depressing a lower portion causes the support 130 to be lowered. After the tire receiving platform 136 has been positioned as desired, a tire assembly 101 is rolled from its storage position onto the tire receiving platform 136. The tire assembly 101 is then rolled inwardly until it passes over the tire engaging support 154 and rolls onto the receiver plate 164. The weight of the tire assembly 101 on the receiver plate 164 causes the receiver plate 164 to rotate downwardly toward the tire cradle plate 158. As the tire assembly 101 begins to lower into the cradle 150, the tire assembly 101 will contact the second receiver plate 164, thereby causing it to rotate downwardly as well. Downward rotation of the receiver plates 164 is halted when each receiver plate 164 contacts the tire cradle plate 158. Downward rotation of the receiver plates 164 also causes restrainer plates 162 to rotate inwardly. So positioned, the restrainer plates 162 maintain the tire assembly 101 in an upright disposition during movement of the tire assembly handling device 100.

Once the tire assembly 101 has been loaded onto the tire assembly handling device 100, the tire assembly handling device 100 is moved into position next to the vehicle (not shown). After the tire assembly handling device 100 has been moved next to the vehicle, the tire assembly 101 is raised to the desired height. For example, the tire assembly 101 is typically raised to a height that is equivalent to that of an axle hub assembly of the vehicle. Once at the desired height, the cradle 150, and subsequently the tire assembly 101, is rotated by exerting force on the handles 182 until the bolt holes of the tire assembly 101 are properly aligned with the matching hub lugs or bolt holes of the axle hub assembly. Next, the tire assembly handling device 100 is urged inwardly toward the vehicle such that the bolt holes of the tire assembly 101 are adjacent the bolt holes of the hub assembly, or else the hub lugs of the hub assembly pass through the bolt holes of the tire assembly 101. Bolts or lug nuts, respectively, are then installed according to the required arrangement. After the tire assembly 101 has been installed on the vehicle, the operator depresses the lift switch 195 thereby causing the elevator 170 to lower the support 130 and associated cradle 150 to an at rest position adjacent the platform 110. The operator then maneuvers the tire assembly handling device 100 away from the vehicle, thereby completing the mounting of the tire assembly 101. The tire assembly handling device 100 can now be placed in storage or used to mount another tire assembly 101 to the vehicle.

Removal of a tire assembly 101 from a vehicle comprises steps similar to those discussed above, performed in a reverse sequence. For example, the tire assembly handling device 100 is first positioned beneath the tire assembly 101 of the vehicle. Next, the cradle assembly 150 is raised until the tire assembly 101 contacts the receiver plates 164 causing them to rotate downwardly. Once the tire assembly 101 is in the cradle 150, the bolts or lug nuts securing the tire assembly 101 to the axle hub assembly are removed, thereby allowing the tire assembly 101 to be lowered. Once the tire assembly 101 has been lowered away from the hub assembly, the tire assembly 101 may now be maneuvered as required about the support surface.

It should be emphasized that the above-described embodiments of the present air assisted tire assembly handling device 100, particularly, any “preferred” embodiments, are merely possible examples of implementations, merely set forth for a clear understanding of the principles of the air assisted tire assembly handling device 100. Many variations and modifications may be made to the above-described embodiments of the air assisted tire assembly handling device 100 without departing substantially from the spirit and principle of the air assisted tire assembly handling device 100. All such modifications and variations are intended to be included herein within the scope of this disclosure of the air assisted tire assembly handling device 100 and protected by the following claims.

1. A device for moving a tire assembly about a floor surface and mounting the tire assembly to a vehicle, comprising:
a platform configured for moving about the floor surface;
a pneumatic source for providing a layer of air between said platform and the floor surface beneath said platform;
a support mounted on said platform, said support defining a horizontally extending central axis and configured to receive and support the tire assembly; and
an elevator connected to said platform and said support, said elevator configured to raise and lower said support relative to said platform;
wherein said device is supported on the layer of air so that the platform is movable above the floor surface.

2. The device of claim 1, further comprising at least one pneumatic caster, disposed on said platform adjacent the floor surface, said at least one pneumatic caster in fluid communication with said pneumatic source.

3. The device of claim 1, further comprising an air restraining skirt, disposed about a periphery of said platform and depending downwardly toward the floor surface, said air restraining skirt configured to retain air from said pneumatic source between said platform and said floor surface.

4. The device of claim 1, wherein said elevator further comprises a pneumatically operated elevator.

5. The device of claim 1, further comprising:
a cradle mounted on said support and rotatable about said central axis, said cradle including a pair of tire engaging supports spaced from each other a distance less than a diameter of the tire assembly, said tire engaging supports for supporting the tire assembly in an upright attitude;
so that the tire assembly positioned in said cradle is elevated to a desired height by said elevator and is rotatable about said central axis to align the tire assembly with the vehicle, and said platform is movable toward the vehicle to engage the tire assembly with the vehicle for mounting.

6. The device of claim 5, further comprising:
a tire tilt restrainer rotatably mounted to one of said tire engaging supports, including;
a bearing sleeve rotatably disposed about said tire engaging support; and
a restrainer plate connected to said bearing sleeve and perpendicular to said central axis, said restrainer plate configured to maintain the tire assembly in an upright position when the tire assembly is supported by said pair of tire engaging supports.

7. A device for moving a tire assembly about a floor surface and mounting the tire assembly to a vehicle, comprising;
a platform configured for moving about the floor surface;
a support mounted on said platform, said support defining a horizontally extending central axis;
an elevator connected to said platform and said support, said elevator configured to raise and lower said support relative to said platform; and
a cradle mounted on said support and rotatable about said central axis, said cradle including a pair of tire engaging supports spaced from each other a distance less than a diameter of the tire assembly, said tire engaging supports for supporting the tire assembly in an upright attitude;
so that the tire assembly positioned in said cradle is elevated to a desired height by said elevator and is rotatable about said central axis to align the tire assembly with the vehicle, and said platform is movable toward the vehicle to engage the tire assembly with the vehicle for mounting.

8. The device of claim 7, further comprising a pneumatic source in fluid communication with said platform, said pneumatic source for providing a layer of air between said platform and the floor surface beneath said platform.

9. The device of claim 8, further comprising a pneumatic caster disposed on said platform adjacent the floor surface, said pneumatic caster being in fluid communication with said pneumatic source.

10. The device of claim 8, further comprising an air restraining skirt disposed about a periphery of said platform and depending downwardly toward the floor surface, said air restraining skirt being configured to retain air from said pneumatic source between said platform and the floor surface.

11. The device of claim 7, wherein:
said support further includes a vertical plate defining a circular opening about said horizontally extending central axis; and
said cradle further includes a plurality of bearings configured to engage said circular opening so that said cradle is rotatable relative to said vertical plate.

12. The device of claim 7, further comprising a pneumatic source in fluid communication with said platform and said elevator, said pneumatic source for providing a layer of air between said platform and the floor surface beneath said platform and for operating said elevator.

13. The device of claim 7, further comprising:
a tire tilt restrainer rotatably mounted to one of said tire engaging supports, including;
a bearing sleeve rotatably disposed about said tire engaging support; and
a restrainer plate connected to said bearing sleeve and perpendicular to said central axis, said restrainer plate configured to maintain the tire assembly in an upright position when the tire assembly is supported by said pair of tire engaging supports.

14. A device for moving a tire assembly about a floor surface and mounting the tire assembly to a vehicle, comprising:
a platform configured for moving about the floor surface;
a support movably connected to said platform and defining a horizontally extending central axis, said support including a pair of tire engaging supports spaced from each other a distance less than a diameter of the tire assembly, said tire engaging supports for supporting the tire assembly in an upright position;
an elevator connected to said platform and said support, said elevator for raising and lowering said support relative to said platform;
a tire tilt restrainer rotatably mounted to one of said tire engaging supports, including;
a bearing sleeve rotatably disposed about said tire engaging support; and
a restrainer plate connected to said bearing sleeve and perpendicular to said central axis, said restrainer plate configured to maintain the tire assembly in an upright position when the tire assembly is supported by said pair of tire engaging supports.

15. The device of claim 8, said tire tilt restrainer further comprising a receiver plate connected to said bearing sleeve, said receiver plate being configured to rotate said bearing sleeve about said tire engaging support when the tire assembly is supported by said pair of tire engaging supports, thereby rotating said restrainer plate into a tire assembly restraining position.

16. The device of claim 15, further comprising a pneumatic source in fluid communication with said platform, said pneumatic source for providing a layer of air between said platform and the floor surface beneath said platform.

17. The device of claim 16, further comprising a pneumatic caster disposed on said platform adjacent the floor surface, said pneumatic caster being in fluid communication with said pneumatic source.

18. A device for moving a tire assembly about a floor surface and mounting the tire assembly to a vehicle, comprising:
a platform configured for moving about the floor surface;
a support mounted on said platform, said support defining a horizontally extending central axis and configured to receive and support the tire assembly;
means for raising and lowering said support relative to said platform;
means for creating a layer of air between said platform and the floor surface; and
wherein said device is supported on the layer of air so that the platform is movable above the floor surface.

19. The device of claim 18, wherein said means for raising further comprise pneumatic means.

20. The device of claim 18, further comprising a cradle mounted on said support and rotatable about said central axis, said cradle including a pair of tire engaging supports spaced from each other a distance less than a diameter of the tire assembly, said tire engaging supports for supporting the tire assembly in an upright attitude.
